(19) United States
(12) Patent Application Publication
(10) Pub. No.: US 2008/0278323 A1
(43) Pub. Date: Nov. 13, 2008

(54) MAIL DETECTION AND NOTIFICATION SYSTEM

(76) Inventor: Wayne Jackson, Houston, TX (US)

Correspondence Address: KELLY LOWRY & KELLEY, LLP, 6320 CANOGA AVENUE, SUITE 1650, WOODLAND HILLS, CA, 91367, US

(21) Appl. No.: 12/115,710

(22) Filed: May 6, 2008

Related U.S. Application Data
(60) Provisional application No. 60/916,447, filed on May 7, 2007.

(51) Int. Cl. G08B 13/22

(52) U.S. Cl. 340/569

(57) ABSTRACT

A system and method is provided for detecting the presence of mail articles in individual mailboxes, and informing the mailbox owner at a remote location of the presence and even sender of such mail articles. The method uses sensors in the mailbox to detect the articles and a scanner to capture images of the articles. Information about the mailbox and articles is stored in electronic memory for remote retrieval, i.e., over the Internet. Automatic alerts may also be sent.

### BACKGROUND OF THE INVENTION

The present invention generally relates to the receipt and tracking of mail and other post in mailboxes. More particularly, the present invention relates to a system and methodology for detecting the presence of mail within a mailbox, and informing a mail recipient that mail is present in his or her mailbox.

Post office boxes are uniquely addressable, lockable boxes. A post office box may be located on the premises of a post office station or mail center and is rented by an individual or business on a monthly or annual basis. The quantity of post office boxes in such post office stations or mail centers can vary widely, with stations of small rural communities being equipped with fewer than one hundred boxes, while stations in a metropolitan area having over one hundred thousand post office boxes. Such post office boxes are usually mounted in a wall of the post office station, either in an external wall or a wall in a lobby, so that staff on the inside may deposit mail in a box, while a key holder on the other side of the wall may open his or her box to empty the mail.

The reasons for obtaining and using a post office box vary, including a user who moves frequently maintaining a consistent mailing address, or a mail recipient desiring a more famous or prestigious address. Businesses receiving large volumes of mail may also maintain separate post office boxes for separate departments to reduce the need to sort internally. Moreover, post office boxes are more secure than many home mail boxes, preventing mail theft and identity theft.

In addition, the United States Postal Service (USPS) is increasingly changing its residential delivery model, by phasing out traditional door-to-door mail delivery, and instead using community-style cluster mailbox systems. Such cluster boxes replace the traditional mailbox in front of the individual's home. This presents a significant cost savings to the USPS in both time and labor costs. It also presents a degree of security to the homeowners as the boxes are locked and the contents cannot be easily obtained, such as by identity thieves and the like.

Large residential buildings, such as high-rise condominiums, apartments, etc. also utilize lockable mailboxes, each box having a uniquely addressable number or code, and means, such as a key, for gaining entrance to the box. Office buildings with multiple tenants also utilize such mailboxes. Physical mailbox systems are increasingly becoming available in commercial mailbox stores. This is due to the fact that the USPS typically does not allow other mail carriers, such as Federal Express, UPS, and other express carriers access to their post office boxes. However, individuals or businesses can have such mail delivered to a commercial mailbox location (such as Kinko's or Mail Boxes Etc.). Each such mailbox has a Personal Mailbox (PMB) number.

While providing some benefits, as described above, there are also drawbacks to having one's mail delivered to a mailbox, whether it be a personal mailbox or a post office mailbox. The primary disadvantage is that the mail recipient must periodically travel to and look in the mailbox to determine if any mail has arrived. In many cases, the mail recipient travels to the mailbox location to find that there is no mail, or only junk mail in the form of advertisements and the like.

Accordingly, there is a continuing need for a system and method to inform mailbox users of the presence of mail within their mailbox. There is also a continuing need for a system which informs the mailbox user of the identity of the mail contained within the mailbox. The present invention fulfills these needs, and provides other related advantages.

### SUMMARY OF THE INVENTION

The present invention is directed to a mail detection and identification process comprising the steps of scanning the interior of a mailbox for the presence of articles or items of mail. Data about the presence of articles in the mailbox is collected and stored in memory. The collected data is then made accessible at a location remote from the mailbox.

The mailbox has a sensor associated therewith for detecting the presence of articles therein. The sensor may comprise a photoelectric, motion, or mechanical sensor.

The collected data may include the number of articles in the mailbox or the weight of the articles in the mailbox. The collected data may be electronically stored in temporary memory associated with the mailbox. Alternatively, the collected data may be stored in electronic memory on a computer server associated with the mailbox. The collected data may also include scanned images of the articles in the mailbox. Electronically readable indicia associated with the mailbox may be generated for each scanned article.

The collected data may be made accessible to an owner of the mailbox over the Internet. Alternatively, the system may be configured to activate an alarm when articles are detected in the mailbox. The alarm may take the form of an e-mail, voice mail, text message or beeper alert.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow chart depicting the steps taken in accordance with the present invention; and

FIG. 2 is a schematic representation of a mailbox according to the present invention.

### DETAILED DESCRIPTION OF THE INVENTION

The present invention resides in a system and method for detecting the presence of mail articles 10 in individual mailboxes 12, and providing means to inform the mailbox owner of the presence, and even identity, of such mail articles. No method currently exists for the mailbox owner to know if there is mail in their box unless the person physically travels to the box to check for the mail, or contacts the location of the mailbox to see if an individual can check for the presence of mail, if such service is available. Of course, this is highly inconvenient, particularly if there is no mail in the mailbox, an individual is not available, or the box contains merely unwanted junk mail.

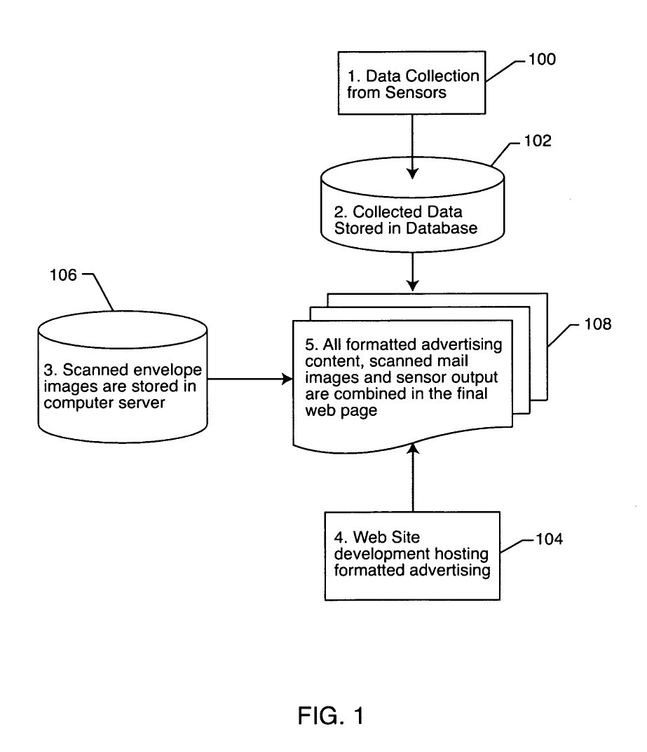

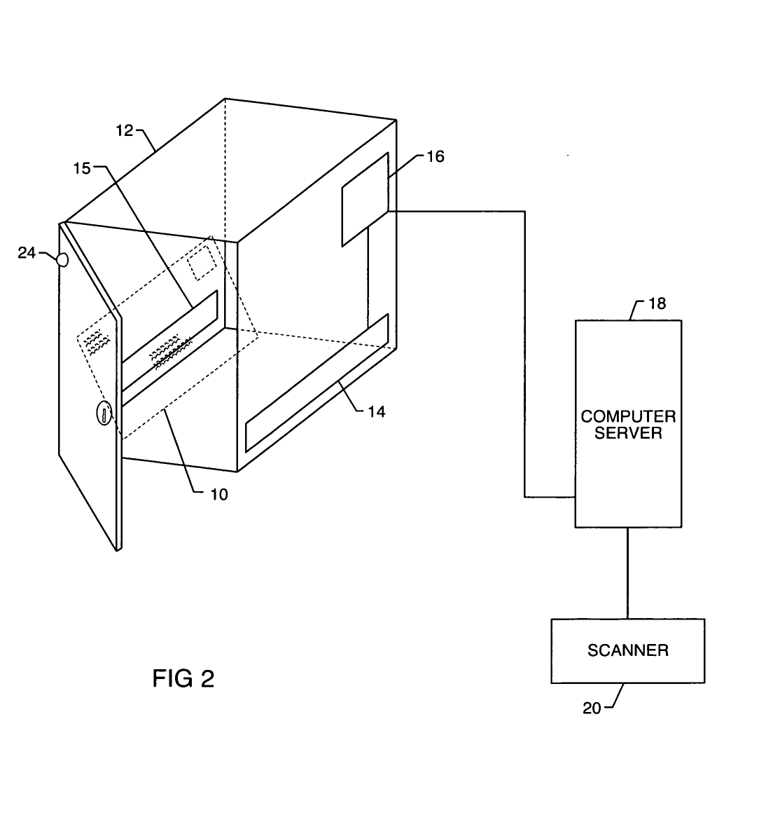

A process as shown in FIG. 1 and a mailbox as illustrated in FIG. 2 embody the present invention. In accordance with the present invention, one or more sensors 14 are operably associated with each participating mailbox 12. The sensors 14 determine whether mail 10 has been added to or is present within the box 12. For example, such sensors 14 can be miniature photo-electric devices that transmit a beam to reflective tape 15 on an opposing surface of the mailbox unit. The mailbox 12 is considered empty if the entire reflective tape 15 is viewed by the sensor 14. However, if less than all of the reflective tape 15 is viewed by the sensor 14, then the box 12 is electronically considered to have content, or mail articles 10 therein. Of course, other sensors 14 can be utilized as well, such as motion sensors, sensors in which a beam of light is broken between the emitter and receiver portion of the sensor, etc. The sensor 14 may also detect the number or weight of articles 10 in the box 12.

Regardless of the type of sensor 14 used, once it is determined that the mailbox unit 12 has articles of mail or post 10 therein, this information is either saved in internal memory 16 for later retrieval, or immediately transmitted, such as to a server 18 or the like. The server 18 may host a web-site wherein users of the system of the present invention can register and log-in to determine if mail articles are present within their mailbox unit. After the user logs in with a unique log-in code, the user is granted access to a web-page indicating whether mail articles are present in the user's mailbox unit.

This may be done with the system interrogating the sensor 14 at the time of log-in, downloading activity events determined by the sensor 14 over time from a database or memory 16 associated with the sensor 14, or the activity occurrences detected by the sensor will have been previously transmitted in real time to the server 18 so that it can be immediately displayed to the user upon log-in. It will be appreciated by those skilled in the art that there are many ways of transferring this information. For example, in some circumstances, the sensors 14 may be electronically connected to wiring which is directly connected to the server 18 which is in turn connected to the Internet, for transmitting the sensor's (and thus the mailbox unit's) unique identifying code, and the occurrence of the sensor detecting the presence of mail articles. This can also be done using a wireless system. Thus, the information can be transmitted immediately in real time, or the sensing devices may transmit their information to data collection systems which temporarily store the data until interrogated. Such sensors, temporary storage devices, etc. may be powered by either AC power, batteries, or solar power.

In any event, once the user logs in and gains access to the appropriate web-page, a notification is provided to the user as to whether the sensor 14 has detected the presence of mail articles 10 within the mailbox unit 12. Typically, the system will also include the location name for the group of mailboxes, the full address including zip code, the time/date the sensors 14 were last polled or activity was last detected, and the status from the last polling. As mentioned above, instead of periodically polling or interrogating the sensors, the sensors 14 may transmit this information in real time, in a wireless or wired manner, with the date and time that the sensor activity took place to alleviate the need for such polling or interrogation. This will alert the user whether there are mail articles in the post office box unit, and thus the user will not unnecessarily travel to the post office box unit.

In a particularly preferred embodiment of the present invention, the outside envelopes of the mail 10 is scanned 20 and the images are stored by name and mailbox number. When the mailbox owner pulls up the web-site and logs in to check the mailbox unit, the web-site displays not only the status of the mailbox (whether or not there are mail articles present), but also the front surfaces of the received mail 10. In this manner, the user can determine the identity of each article of mail 10, and view the names of the mail senders. This may be done in a scrolling window, by clicking on thumbnail images, etc. In this manner, the owner of the mailbox 12 can determine not only that mail articles 10 are present within the mailbox 12, but also determine if it is worth the trip to the mailbox unit to retrieve the mail.

The scanning of the outside of the mail 10 articles can be done on a per mailbox basis, with providers of the service of the present invention retrieving and scanning such mail articles. However, more preferably, it is the mail service providers (such as the USPS, FedEx, UPS, etc.) that scan the mail articles 10 and download the scanned images to the web-site for later retrieval. Optical character recognition software or internal tracking codes, such as barcodes and the like, etc. may be used to assign each scanned mail article 10 to a particular mail recipient and user of the system. Thus, the user will only be able to have access to images of the mail articles 10 that are addressed to that user.

With reference now to FIG. 1, a full diagram illustrates the steps taken in accordance with the present invention. First, data is collected from the individual sensors 14 (100). Then, the collected data is stored in a database (102), whether it be a temporary database 16 associated with the sensor 14, or the data is transmitted to a computer server 18 or the like. This information alone can be made available to the user through the web-site interface (104).

In the particularly preferred embodiment described above, scanned 20 envelope images are stored in the system's database 18 (106). The web-site development hosting company can combine and format any advertising, graphics, scanned mail images, and sensor output for display on the web page (108).

It is contemplated that the users can pay a weekly or monthly access fee to retrieve information as to whether mail articles are present within their mailbox units. A premium subscription for an additional fee will yield the images of the scanned envelopes and other mail articles. It is contemplated by the present invention that either access to the sensor information and/or scanned mail article images could be offered for free if sufficient on-line advertising revenue were generated. In fact, offering the data relating to the sensors (whether there are mail articles present in the mailbox unit) for free could result in a very large number of users accessing the web-site on a regular basis, making the web-site more appealing to advertisers, thus increasing advertising revenue and enabling at least this portion of the service free of charge.

The system may also include an alarm or alert that is activated when articles 10 are detected in the mailbox 12. The alarm or alert may take the form of an LED 24 mounted in the front of the mailbox 12. The alarm or alert may also take the form of some form of electronic notice, i.e., e-mail, voice mail, text message, beeper alert, or similar notification to the owner of the mailbox 12 when articles are present therein. The alarm or alert may be activated automatically upon the scanning of articles in the mailbox. Alternatively, the alarm or alert may be activated only upon query by the owner of the mailbox. For example, the owner of a mailbox may call into a service or log in to the web-site which will automatically trigger the system to scan for the presence of articles 10 in the mailbox 12. Upon such activation by the owner, the system may generate the electronic notification which contains specifics about the articles 10 in the mailbox 12.

Although several embodiments have been described in detail for purposes of illustration, various modifications may be made without departing from the scope and spirit of the invention. Accordingly, the invention is not to be limited, except as by the appended claims.

What is claimed is:

1. A mail detection and identification process, comprising the steps of:
scanning the interior of a mailbox to detect the presence of articles;
collecting data about the presence of articles in the mailbox;
storing the collected data; and
making the collected data accessible at a location remote from the mailbox.

2. The process of claim 1, including a sensor associated with the mailbox for detecting the presence of articles therein.

3. The process of claim 2, wherein the sensor comprises a photo-electric, motion, or mechanical sensor.

4. The process of claim 1, wherein the collected data includes the number of articles in the mailbox or the weight of the articles in the mailbox.

5. The process of claim 1, wherein the collected data is electronically stored in temporary memory associated with the mailbox.

6. The process of claim 1, wherein the collected data is stored in memory on a computer server associated with the mailbox.

7. The process of claim 1, further comprising the step of scanning images of the articles in the mailbox.

8. The process of claim 7, wherein the step of collecting data includes collecting the scanned images.

9. The process of claim 7, further comprising the step of generating electronically readable indicia associated with the mailbox for each scanned image.

10. The process of claim 1, further comprising the step of activating an alarm when articles are detected in the mailbox.

11. The process of claim 10, wherein the activating an alarm step utilizes e-mail, voice mail, text message or beeper alert.

12. The process of claim 1, wherein the collected data is made accessible over the Internet.

13. A mail detection and identification process, comprising the steps of:
scanning the interior of a mailbox with a sensor associated with the mailbox to detect the presence of articles therein;
scanning images of the articles in the mailbox;
collecting data about the presence of articles in the mailbox;
storing the collected data; and
making the collected data accessible at a location remote from the mailbox.

14. The process of claim 13, wherein the sensor comprises a photo-electric, motion, or mechanical sensor.

15. The process of claim 13, wherein the collected data includes the number of articles in the mailbox or the weight of the articles in the mailbox.

16. The process of claim 13, wherein the collected data is electronically stored in temporary memory associated with the mailbox.

17. The process of claim 13, wherein the collected data is stored in memory on a computer server associated with the mailbox.

18. The process of claim 13, wherein the step of collecting data includes collecting the scanned images.

19. The process of claim 13, further comprising the step of generating electronically readable indicia associated with the mailbox for each scanned image.

20. The process of claim 13, further comprising the step of activating an alarm when articles are detected in the mailbox.

21. The process of claim 20, wherein the activating an alarm step utilizes e-mail, voice mail, text message or beeper alert.

22. The process of claim 13, wherein the collected data is made accessible over the Internet.

23. A mail detection and identification process, comprising the steps of:
scanning the interior of a mailbox with a photo-electric, motion, or mechanical sensor associated with the mailbox to detect the presence of articles therein;
scanning images of the articles in the mailbox;
generating electronically readable indicia associated with the mailbox for each scanned image;
collecting data including the number, the weight or the scanned images of the articles in the mailbox;
storing the collected data electronically in temporary memory associated with the mailbox or in memory on a computer server associated with the mailbox;
making the collected data accessible over the Internet at a location remote from the mailbox; and
activating an alarm utilizes e-mail, voice mail, text message or beeper alert when articles are detected in the mailbox.
